(19) United States
(12) Patent Application Publication
(10) Pub. No.: US 2013/0323547 A1
(43) Pub. Date: Dec. 5, 2013

(54) BREAKER, SAFETY CIRCUIT WITH BREAKER AND SECONDARY BATTERY WITH BREAKER

(71) Applicant: KOMATSULITE MFG. CO., LTD., Osaka (JP)

(72) Inventor: Masashi NAMIKAWA, Suita-shi (JP)

(73) Assignee: KOMATSULITE MFG. CO., LTD., Osaka (JP)

(21) Appl. No.: 13/901,622

(22) Filed: May 24, 2013

(30) Foreign Application Priority Data
May 25, 2012 (JP) 2012-120057

(51) Int. Cl. H01H 37/04

(52) U.S. Cl. CPC H01H 37/04
USPC 429/61; 337/298; 361/115

(57) ABSTRACT

A digging-into portion 91 formed in a fixed part 42 of a movable piece 4 digs into and fits with a protrusion 74a of a resin casing 71, and the movable piece 4 is firmly fixed to the resin casing 71. Thereby, the posture of the movable piece 4 relative to the resin casing 71 is stabilized, and the positional relation between the fixed contact and the movable contact is stabilized.

### BACKGROUND OF THE INVENTION

1. Technical Field of the Invention

The present invention relates to a minisize breaker built into a secondary battery pack for an electrical equipment and the like.

2. Description of the Related Art

Heretofore, a breaker is employed as a protection equipment (safety circuit) for a secondary battery, electric motor and the like in various electrical equipments.

If an abnormal situation happens, for example, the temperature of the secondary battery is excessively increased during discharging or being charged, or an overcurrent flows in an electric motor or the like provided in an equipment, e.g. automobile, home electric appliance and the like, then the breaker shuts off the current to protect the secondary battery, electric motor and the like.

Such breaker used as a protection equipment is, in order to ensure the safety of the equipment, required to exactly function in response to temperature change (to have good temperature property) and also required to have a stable resistance value in the conduction state.

when a breaker is used as a protection equipment for a secondary battery and the like provided in an electrical equipment such as a notebook-size personal computer, a tablet type handheld terminal and a thin-shaped multifunctional mobile-phone called “smartphone”, miniaturization is required in addition to the above-mentioned ensuring of the safety of the equipment.

In the case of the recent handheld terminals, in particular, the users' preferences toward miniaturization (thin-shaped) are strong.

Equipments newly launched on the market by various manufacturers have a strong tendency to have miniaturized designs in order to obtain superiority in the design.

Under such circumstances, a breaker—mounted together with a secondary battery, as one of component parts of a handheld terminal—is also strongly required to be further miniaturized.

The breaker is provided with a thermal actuator element operating in response to temperature changes so as to pass or shut off an electric current.

In Patent document 1, a breaker in which a bimetal is used as a thermal actuator element is disclosed.

A bimetal is formed by laminating two kinds of platy metal materials having different coefficients of thermal expansion.

The bimetal is an element which changes its shape in response to temperature changes and controls conduction/nonconduction states of the contacts.

The breaker disclosed in the document is composed of parts which are a fixed piece (base terminal), a movable piece (movable arm), a thermal actuator element, a PTC thermistor and the like and which are put in a casing.

In order to use, the terminals of the fixed piece and the movable piece are connected to an electrical circuit of an electrical equipment.

In the breaker disclosed in the patent document 1, a lid member is ultrasonic welded to the main portion of the casing to unify the casing, and a fixed part is sandwiched between the lid member (covering member) and the casing main portion from both sides of the fixed part. Thereby, the position of the movable piece is fixed. (see paragraph (0032), (0037) of the document).

Patent document 1 WO2011/105175

Usually, a breaker is connected by welding or the like to electrically conductive leads provided between a secondary battery and a circuit board constituting a safety circuit. In recent years, it is considered that a breaker is directly mounted on a circuit board as shown in FIG. 11 and FIG. 12, aimed at increased production efficiency.

As shown in FIG. 11, the secondary battery circuit 200 has a secondary battery pack 201, a safety circuit 202, etc. The secondary battery of the secondary battery pack 201 is connected to an electrically conductive lead 205 of the safety circuit 202 through a terminal 203.

The breaker 1 is connected to the electrically conductive lead 205 so as to be series-connected to an output circuit of the secondary battery.

As shown in FIG. 12, the terminals 22, 41 of the breaker 1 are connected to the electrically conductive leads 205 of a circuit board 204 of the safety circuit 202 by the use of solder 206.

As to the soldering, the use of reflow soldering is considered because, by setting the breaker 1 on the circuit board 204 together with other electronic parts constituting the safety circuit 202, and performing the reflow soldering, it is possible to make the soldering of all the parts at the same time, and thereby to eliminate the need for the above described welding process.

In the prior art breaker, when the lid member of the breaker is excessively heated during the heating process of the reflow soldering, there is a possibility that the lid member is slightly deformed.

Thus, in the structure in which the fixed part is sandwiched between the lid member and the casing main portion, there is a possibility that it becomes difficult to maintain the proper position of the movable piece.

Especially, in the case of the breaker having such a structure that the lid member is positioned on the upper side of the breaker,

there is a tendency that the lid member is excessively heated during reflow soldering, therefore, there is concern about the above explained difficulty.

If the position of the movable piece is changed due to the overheating of the lid member, then the positional relation between a movable contact formed in a tip section thereof and a fixed contact formed in the casing main portion is also changed, and there is a possibility that the contact resistance between the contacts under the conduction state is affected.

Further, the variation of the positional relation between the movable contact and the fixed contact is a factor of the deterioration in the temperature property of the breaker.

Such defect is considered as a problem becoming significant as the miniaturization of the breaker is sought.

### SUMMARY OF THE INVENTION

In order to solve the above-mentioned problem, the present invention was made, and an object thereof is to provide a breaker which is compatible with heating processes of reflow soldering and the like and in which a stable resistance value can be obtained under the conduction state and good temperature property can be obtained.

In a breaker having
a fixed piece having a fixed contact,
a movable piece having an elastic portion being elastically deformable and a movable contact in a tip section of the elastic portion, for pressing the movable contact to the fixed contact so as to contact therewith,
a thermal actuator element for actuating the movable piece so that the movable contact is separated from the fixed contact by its deformation in response to a temperature change, and
a casing for housing the fixed piece, the movable piece and the thermal actuator element,
   the present invention is, in order to achieve the above object, characterized in that
the above-mentioned casing has
   a first casing molded with the fixed piece inserted, and
   a second casing mounted on the first casing, and
the movable piece is provided with a digging-into portion digging into the first casing.

In this invention, it is desirable that the movable piece has a fixed part fixed to the casing by being sandwiched between the first casing and the second casing, and the digging-into portion is formed in the fixed part.

In this invention, it is desirable that a plurality of the digging-into portions are formed intermittently.

In this invention, it is desirable that a plurality of the digging-into portions are shifted in the direction in which the elastic portion extends.

In this invention, it is desirable that the digging-into portion is formed at an edge of the fixed part.

According to the configuration in which a plurality of the digging-into portions are formed intermittently, the digging-into portions can be elastically deformed independently from each other, and

their elastic moduli can be optimized individually, therefore, the bonding force between the digging-into portions and the first casing can be controlled, and
it becomes possible to easily perform the process for mounting the movable piece in the first casing.

In this invention, it is desirable that the movable piece has a through hole into which a part of the first casing is inserted, and

the digging-into portion is formed so as to protrude from the peripheral edge of the through hole.

In this invention, it is desirable that the movable piece is placed in the first casing from its rear surface side where the movable contact is provided, and

the digging-into portion is bent or curved so that the tip end jut out toward the front surface side of the movable piece

A safety circuit for an electrical equipment according to the present invention is characterized by having the above-mentioned breaker.

A secondary battery circuit according to the present invention is characterized by having the above-mentioned breaker.

According to the breaker of the present invention, the digging-into portion formed in the movable piece digs into the first casing, and thereby the position of the movable piece is fixed in relation to the first casing. In other words, regardless of the deformation of the second casing, the movable piece is tightly fixed to the first casing by the digging-into portion.

Therefore, even if the second casing is deformed by over heat during reflow soldering in which the breaker is mounted in the safety circuit and connected to the safety circuit,

there is no possibility of affecting the position of the movable piece relative to the first casing.

In this regard, by placing the breaker on the circuit board such that the second casing is oriented toward the blasts of hot air during the reflow soldering,

the second casing protects the first casing from the blasts of hot air, and the deformation of the first casing can be suppressed.

Therefore, before and after the reflow soldering, the positional relation between the movable contact formed in the tip end of the movable piece and the fixed contact embed in the first casing becomes stable, and

the contact resistance between the contacts in the conduction state is reduced, and
it becomes possible to maintain a good temperature property of the breaker.

According to the configuration in which the digging-into portion is formed in the fixed part sandwiched between the first casing and the second casing,

owing to synergistic action of the fixed part and the digging-into portion,
the fixation of the movable piece to the casing becomes more strong, and
it is possible to improve the positional stability of the movable piece.

According to the configuration in which a plurality of the digging-into portions are shifted in the direction in which the elastic portion extends,

the digging-into portions dig into the first casing at a plurality of points in the direction in which the elastic portion extends, and the movable piece is fixed to the first casing, therefore,
it becomes possible to further stabilize the position of the movable piece (especially, the position of the tip end of the elastic portion in which the movable contact is provided).

According to the configuration in which the digging-into portion is formed so as to protrude from the peripheral edge of the through hole into which a part of the first casing is inserted,

when the movable piece is mounted on the first casing, the positioning of the movable piece can be made readily and accurately by inserting the part of the first casing into the through hole.

Further, since the structure for the positioning of the movable piece serves as the structure for the fixation, it is possible to simplify the structure of the breaker.

According to the configuration in which the digging-into portion is formed at the edge of the fixed part, as the digging-into portion digs into the first casing at the edge of the fixed part,

the movable piece is further strongly fixed to the first casing. For example, by forming the digging-into portion so as to face a side wall of the first casing at the edge of the fixed part, it is possible to fix the movable piece to the side wall which is a stiff principal structural part of the first casing, and it becomes possible to further stabilize the position of the movable piece.

According to the configuration in which the movable piece is mounted in the first casing from the rear surface side where the movable contact is provided, and the digging-into portion is bent or curved so that the tip end juts out toward the front surface side of the movable piece,

when the movable piece is separated from the first casing, the bent or curved digging-into portion becomes flat, and the amount of digging of the tip end is increased. Thereby, the bind between the movable piece and the first casing becomes stronger, and the separation of the movable piece can be prevented.

According to a safety circuit or a secondary battery circuit having the breaker according to the present invention, it is possible to produce the safety circuit or the secondary battery circuit which is compatible with heating processes of reflow soldering and the like and in which a stable resistance value under the conduction state and good temperature property can be obtained.

### BRIEF EXPLANATION OF THE DRAWINGS

FIG. 1 is a perspective assembling drawing showing a structure of the breaker according to the present invention.

FIG. 2 is a cross sectional view showing the breaker in a usual operating state of charge or discharge.

FIG. 3 is a cross sectional view showing the breaker in a state of overcharge or abnormal state.

FIG. 4 is a plan view showing the same breaker as seen through the covering member.

FIG. 5 is a perspective view showing the structure of the movable piece applied to the same breaker.

FIG. 6 is cross sectional views showing a time-series state in which the movable piece is mounted on a resin base and then the covering member is mounted.

FIG. 7 is enlarged cross sectional views showing the vicinity of the digging-into portion of the same breaker.

FIG. 8 is a perspective view showing a modified example of the movable piece.

FIG. 9 is a perspective view showing another modified example of the movable piece.

FIG. 10 is a perspective view showing still another modified example of the movable piece.

FIG. 11 is a plan view showing a structure of the secondary battery circuit having the breaker according to the present invention.

FIG. 12 is a cross sectional view showing the breaker according to the present invention which is mounted on the substrate of the safety circuit.

### DESCRIPTION OF THE PREFERRED EMBODIMENTS

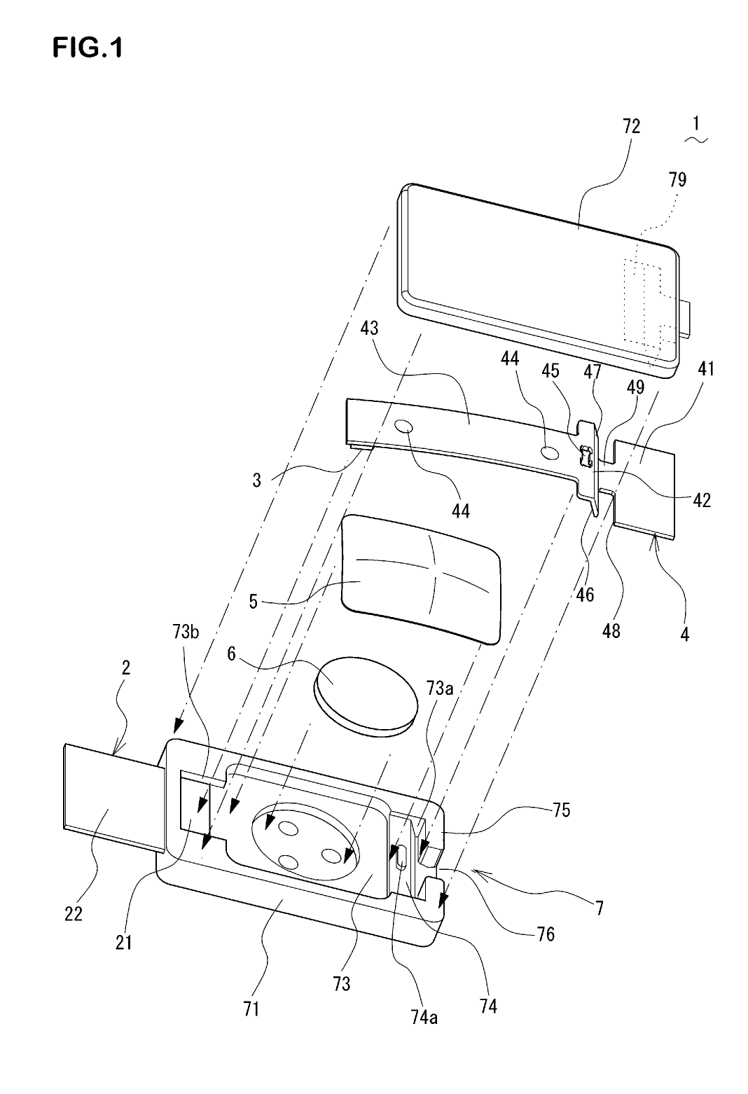

A breaker according to an embodiment of the present invention will now be described in reference to the drawings. FIGS. 1-3 show the structure of the breaker.

The breaker 1 is constructed by

a fixed piece 2 having a fixed contact 21,
a movable piece 4 having a movable contact 3 in the tip section,
a thermal actuator element 5 deformable in response to a temperature change,
a PTC (Positive Temperature Coefficient) thermistor 6, and
a casing 7 for housing the fixed piece 2, the movable piece 4, the thermal actuator element 5 and the PTC thermistor 6 and the like.

The casing 7 is composed of a resin base (first casing) 71, a covering member (second casing) 72 mounted on the upper surface of the resin base 71 and the like.

From a metal sheet composed mostly of phosphor bronze (also, a metal sheet of a copper-titanium alloy, nickel silver, brass or the like), the fixed piece 2 is formed through press working, and embedded in the resin base 71 through insert molding.

A terminal 22 for being electrically connected to the outside is formed at one end of the fixed piece 2. Near the other end, the PTC thermistor 6 is placed thereon.

The PTC thermistor 6 is placed on small protrusions formed at three positions near the other end of the fixed piece 2.

The fixed contact 21 is formed at a position facing the movable contact 3 by clading, plating or applying a material having a good electrical conductivity, e.g. silver, nickel, a nickel-silver alloy, a copper-silver alloy, a gold-silver alloy and the like.

The fixed contact 21 is exposed through an opening 73b formed on the upper side of the resin base 71.

The terminal 22 is exposed to the outside penetrating through one end of the resin base 71.

The movable piece 4 is formed, in a form of an arm symmetrical about its longitudinal center line, from a sheet of a metal material through press working.

As to the material of the movable piece 4, a material which is, similarly to the fixed piece 2, composed mostly of phosphor bronze is preferably used.

In addition, electrically-conductive elastic materials such as copper-titanium alloy, nickel silver and brass can be used.

At one end of the movable piece 4 in its longitudinal direction, a terminal 41 which is electrically connected to an outside circuit, is formed so as to be exposed to the outside penetrating through the resin base 71.

At the other end of the movable piece 4 (corresponding to the tip end of the movable piece 4 as an arm), the movable contact 3 is formed.

The movable contact 3 is made of a material similar to the fixed contact 21 and joined with a tip section of the movable piece 4 through a technique of welding or the like.

In this application, the surface of the movable piece 4 with which the movable contact 3 is joined (namely, the downside surface in FIG. 1) is referred as “rear surface”. The opposite surface (surface facing the covering member 72) is referred as “front surface”.

The movable piece 4 is provided between the movable contact 3 and the terminal 41 with a fixed part 42 (corresponding to the base end of the movable piece 4 as an arm) and an elastic portion 43.

The movable piece 4 is fixed, in the fixed part 42, by being sandwiched between the resin base 71 and the covering member 72 from the rear surface side and the front surface side.

The elastic portion 43 is elastically deformed and the movable contact 3 formed at the tip end is forced toward the fixed contact 21 to contact therewith.

Thus, electricity can flow through between the fixed piece 2 and the movable piece 4.

The resin base 71 and the covering member 72 are respectively provided with a contacting part 74 and a contacting part 79 (cf. FIG. 1) for contacting with the fixed part 42 of the movable piece 4 to keep the fixed part 42 in its fixed state.

In this embodiment, the contacting part 74 is formed in a region extending from an outer edge of an accommodation part 73 of the resin base 71 to an outer wall of the resin base 71.

The contacting part 79 is formed in a region of the covering member 72 which region includes a stepped part 77 and faces the contacting part 74 through the movable piece 4.

The movable piece 4 is mounted in the resin base 71 from the rear surface side on which the movable contact 3 is provided.

The fixed part 42 contacts, in its rear surface, with the contacting part 74 of the resin base 71, and the fixed part 42 contacts, in its front surface, with the contacting part 79 of the covering member 72.

The movable piece 4 is fixed to the casing 7 as a result of the fixed part 42 secured between the contacting part 74 and the contacting part 79 from the rear surface side and the front surface side.

The elastic portion 43 of the movable piece 4 is bent or curved through press working.

The degree of the bending or curving is not limited as far as the thermal actuator element 5 can be mounted. It can be arbitrarily determined with consideration for the elastic force, contact point pressure and the like at the operating temperature and return temperature.

The lower surface of the elastic portion 43 is provided with a pair of small protrusions 44 facing the thermal actuator element 5.

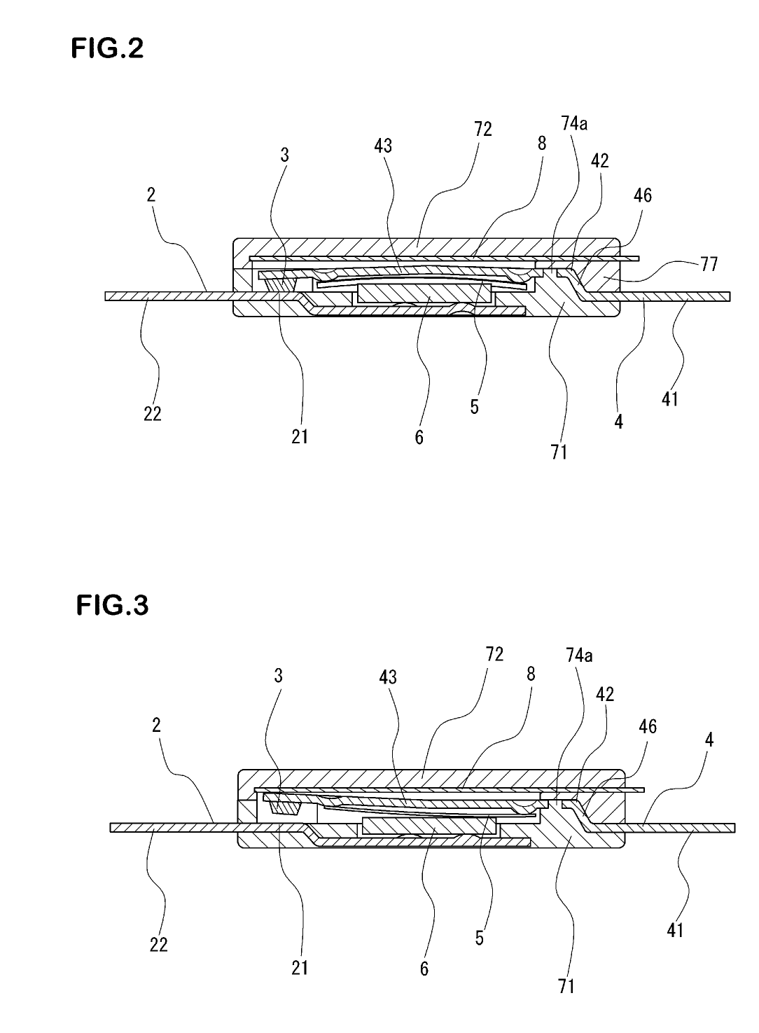

The small protrusions 44 contact with the thermal actuator element 5, and the deformation of the thermal actuator element 5 is transmitted through the small protrusions 44 to the elastic portion 43 (cf. FIG. 2 and FIG. 3).

The movable piece 4 is provided with

a through hole 45 which penetrates through the movable piece 4 in its thickness direction and through which a protrusion 74a of
the resin base 71 is inserted,
a stepped bent part 46 in the form of a crank,
a slope 47 formed in the stepped bent part 46,
a pair of engaging parts 48 engaging with a positioning part 75 of the resin base 71, and
a constricted part 49 where a part of the movable piece 4 is removed by cutting in the short direction perpendicular to the longer direction of the movable piece 4.

The through hole 45, stepped bent part 46, slope 47, engaging part 48 and constricted part 49 are formed on the other side of the elastic portion 43 opposed to the movable contact 3, namely, on the terminal 41 side of the elastic portion 43.

The through hole 45 is formed on the longitudinal center line of the movable piece 4.

The slope 47 is formed continuously along a direction of the movable piece 4.

The engaging part 48 is formed at two positions along the short direction of the movable piece 4.

The through hole 45 is formed in the fixed part 42 of the movable piece 4.

The fixed part 42 is formed to be wider in the short direction of the movable piece 4 than the elastic portion 43.

Thereby, the area of the cross section perpendicular to the longer direction of the movable piece 4 becomes larger in the fixed part 42 than in the elastic portion 43.

The through hole 45 is formed in the form of an oval or ellipse being long in the short direction of the movable piece 4 in a plan view (viewed in the thickness direction of the movable piece 4).

The engaging part 48 is formed by the edge of the constricted part 49 on the terminal 41 side.

The constricted part 49 is disposed on the other side of the fixed part 42 than the elastic portion 43 and between the fixed part 42 and the terminal 41.

It is desirable that the width dimension of the constricted part 49 (length dimension in the short direction of the movable piece 4, the same hereinafter) is set to be not more than the width dimension of the elastic portion 43. It is good to set the width dimension less than those of at least the fixed part 42 and the terminal 41.

The constricted part 49 in this embodiment has the function of the second elastic portion in the aforementioned patent document 1, and absorbs external force and shock which the terminal 41 receives, and properly keeps the position of the movable contact 3.

The thermal actuator element 5 is made of a composite material such as bimetal and trimetal and has an initial shape curved like an arc.

When reached to the operating temperature by overheating, the curved shape is reversely curved, accompanying a snap motion, and restored when cooled down to below the return temperature.

The initial shape of the thermal actuator element 5 can be given through press working.

The material and shape of the thermal actuator element 5 are not particularly limited as far as the elastic portion 43 of the movable piece 4 is pressed up, at the desired temperature, by the reversely curving motion of the thermal actuator element 5, and it is restored to the original by the elastic force of the elastic portion 43.

But, from a point of view of the production efficiency and the efficiency of the reversely curving motion, a rectangle is desirable.

In order to effectively press up the elastic portion 43 though a small size, a rectangle close to a square is desirable.

As to the material of the thermal actuator element 5, a laminate of two kinds of materials having different coefficients of thermal expansion is used.

Various alloys, for example, a copper-nickel-manganese alloy and a nickel-chromium-iron alloy used on the high expansion side, and an iron-nickel alloy, a nickel silver, a brass, a stainless steel used on the low expansion side are used in combination according to the requirements.

If the conduction between the fixed piece 2 and the movable piece 4 is broken by the reversely curving motion of thermal actuator element 5, then an electric current flowing through the PTC thermistor 6 is increased.

As to the PTC thermistor 6, as far as it is a positive temperature coefficient thermistor whose resistance value is increased with increase in the temperature and which restrict the flow of electrical current,

its type can be selected according to requirements such as the operating current, operating voltage, operating temperature and return temperature, and
its shape is not limited as far as these characteristics are not impaired.

The resin base 71 and the covering member 72, which constitute the casing 7, are molded from resin such as burn-resistant polyamide, heat-resistant polyphenylene sulfide (PPS), liquid crystalline polymer (LCP) and polybutylene terephthalate (PBT).

The resin base 71 is provided with

the accommodation part 73 for housing the thermal actuator element 5 and the PTC thermistor 6, and
openings 73a and 73b for housing the movable piece 4.

The edges of the thermal actuator element 5 and the PTC thermistor 6, which are mounted in the resin base 71, are contacted by rims formed in the accommodation part 73 and guided when the thermal actuator element 5 is reversely curved.

The resin base 71 has

the protrusion 74a inserted through the through hole 45 of the movable piece 4 and engaged therewith,
a pair of the positioning parts 75 for positioning the movable piece 4, and
a window 76 for exposing the terminal 41 of the movable piece 4 to the outside.

The protrusion 74a is formed in the form of oval in the plan view in accordance with the through hole 45 and reinforces the resin base 71.

The height of the protrusion 74a or the amount of protruding, is set to be more than the thickness of the movable piece 4.

The rear surface of the covering member 72 is provided with a recess for the top of the protrusion 74a as needed basis.

The positioning part 75 is formed at two positions along a direction perpendicular to the longer direction of the movable piece 4.

In this embodiment, due to the presence of the window 76, a part of the side wall of the resin base 71 is shaped to accord with the constricted part 49 of the movable piece 4, and forms the positioning part 75. Namely, the positioning part 75 exists in the removed part near the constricted part 49, and reinforces the resin base 71.

The covering member 72 has a stepped part 77 protruding from its inner wall surface in the form corresponding to the stepped bent part 46 of the movable piece 4, and a slope 78 (cf. FIG. 5) formed in the stepped part 77.

The slope 78 corresponds to the slope 47 of the movable piece 4, and is formed continuously in a direction perpendicular to the longer direction of the movable piece 4.

A covering piece 8 is embedded in the covering member 72 by means of insert molding.

The covering piece 8 is formed by press working from the above-mentioned metal sheet composed mostly of phosphor bronze, a metal sheet of stainless steel or the like.

As shown in FIG. 2 and FIG. 3, the covering piece 8 contacts with the upper surface of the movable piece 4 to control the motion of the movable piece 4, and also increases the stiffness and strength of the covering member 72 and accordingly those of the casing 7.

As shown in FIG. 1, the covering member 72 is mounted on the upper surface of the resin base 71 so as to close the accommodation part 73 of the resin base 71 housing the fixed piece 2, the movable piece 4, the thermal actuator element 5 and the PTC thermistor 6.

The resin base 71 and the covering member 72 are joined together for example by means of ultrasonic welding.

FIG. 2 shows the behavior of the breaker 1 in its normal state of charge or discharge.

In the normal state of charge or discharge, the thermal actuator element 5 keeps the initial shape (before reversely curved), and the fixed contact 21 and the movable contact 3 contact with each other, therefore the breaker 1 is conductive between the both of the terminals 22 and 41 through the elastic portion 43 of the movable piece 4 etc.

The elastic portion 43 of the movable piece 4 contacts with the thermal actuator element 5.

The movable piece 4, the thermal actuator element 5, the PTC thermistor 6 and the fixed piece 2 are conductive as a circuit.

But, the resistance of the PTC thermistor 6 is very high when compared with the resistance of the movable piece 4, therefore, the electric current flowing through the PTC thermistor 6 is practically negligibly-small when compared with that flowing through the fixed contact 21 and the movable contact 3.

FIG. 3 shows the behavior of the breaker 1 in a state of overcharge or abnormal condition.

When becoming in a high-temperature state by overcharging or abnormality, the PTC thermistor 6 is overheated, and the thermal actuator element 5 reaching to the operating temperature is reversely curved, and the elastic portion 43 of the movable piece 4 is pushed up, and the movable contact 3 is separated from the fixed contact 21.

The electric current flowing between the fixed contact 21 and the movable contact 3 at the time is interrupted, and a very small leak current flows through the thermal actuator element 5 and the PTC thermistor 6.

In so far as such leak current flows, the PTC thermistor 6 generates heat and keeps the reversely curved state of the thermal actuator element 5 which greatly increases the resistance value.

Therefore, no current flows between the fixed contact 21 and the movable contact 3, and

only the above-mentioned small leak current flows (self-holding circuit is formed).

The leak current may be used for another function of a safety system.

By eliminating the overhanging state or resolving the abnormal state, the heat generation of the PTC thermistor 6 is stopped, and the thermal actuator element 5 becomes the return temperature and restores its initial shape.

Then, due to the elastic force of the elastic portion 43 of the movable piece 4, the movable contact 3 again contacts with the fixed contact 21 to end the cut-off state of the circuit and return to the conduction state shown in FIG. 2.

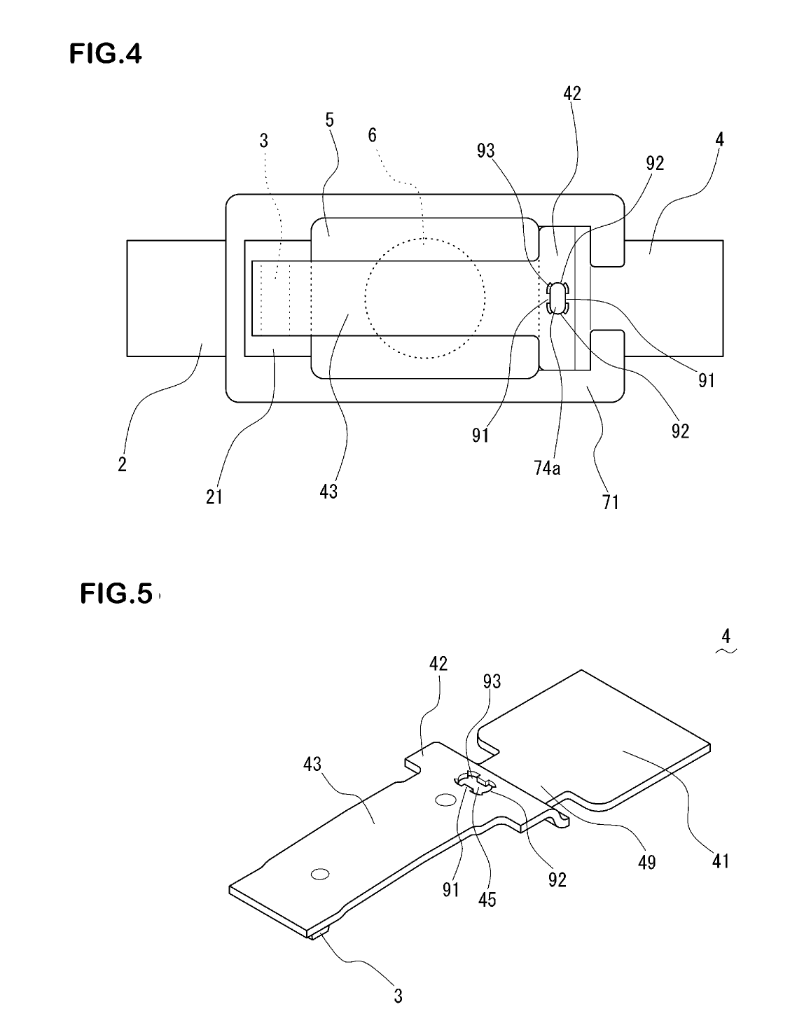

FIG. 4 shows a plan view of the breaker 1 through the covering member 72. FIG. 5 shows the structure of the movable piece 4.

The protrusion 74a of the resin base 71 is formed in the form of an oval or ellipse in the plan view, and the through hole 45 of the movable piece 4 is formed in a basic shape corresponding thereto.

The movable piece 4 has two pairs of the digging-into portions 91 and 92.

The digging-into portions 91 and 92 are formed so that, in the fixed part 42, they protrude from the peripheral edge of the through hole 45 toward the inside, in other words, when the movable piece 4 is mounted in the resin base 71, they protrude from the peripheral edge of the through hole 45 toward the protrusion 74a.

The paired digging-into portions 91 are arraigned side by side in the longer direction of the movable piece 4, namely, a direction parallel to the direction to which the elastic portion 43 extends so that they become opposite with interposing the protrusion 74a therebetween. In other words, the paired digging-into portions 91 are shifted in the direction to which the elastic portion 43 extends.

The paired digging-into portions 92 are arraigned side by side in the short direction of the movable piece 4, namely, a direction perpendicular to the direction to which the elastic portion 43 extends so that they become opposite with interposing the protrusion 74a therebetween.

The distance between the tip ends of the opposed digging-into portions 91 is set to be slightly smaller than the minor axis of the protrusion 74a.

similarly, the distance between the tip ends of the opposed digging-into portions 92 is set to be slightly smaller than the major axis of the protrusion 74a.

Between the digging-into portions 91 and between the digging-into portions 92, through-holes 93 are punched out by press working or the like, and

by the through-holes 93, the adjacent digging-into portions 91 and digging-into portion 92 are separated from each other. Namely, by forming the through-holes 93, two pairs of the digging-into portions 91 and 92 are intermittently formed at the peripheral edge of the through hole 45, and they are elasticity deformable independently from each other.

By arbitrarily changing the shape and dimensions of the through-holes 93, the elastic forces of the digging-into portions 91 and 92 can be controlled.

In this embodiment, by the through hole 45 and the through-holes 93, a keyhole-like through hole is formed in the fixed part 42. Corresponding to the keyhole-like through hole, convexo-concave may be provided on the side surface of the protrusion 74a.

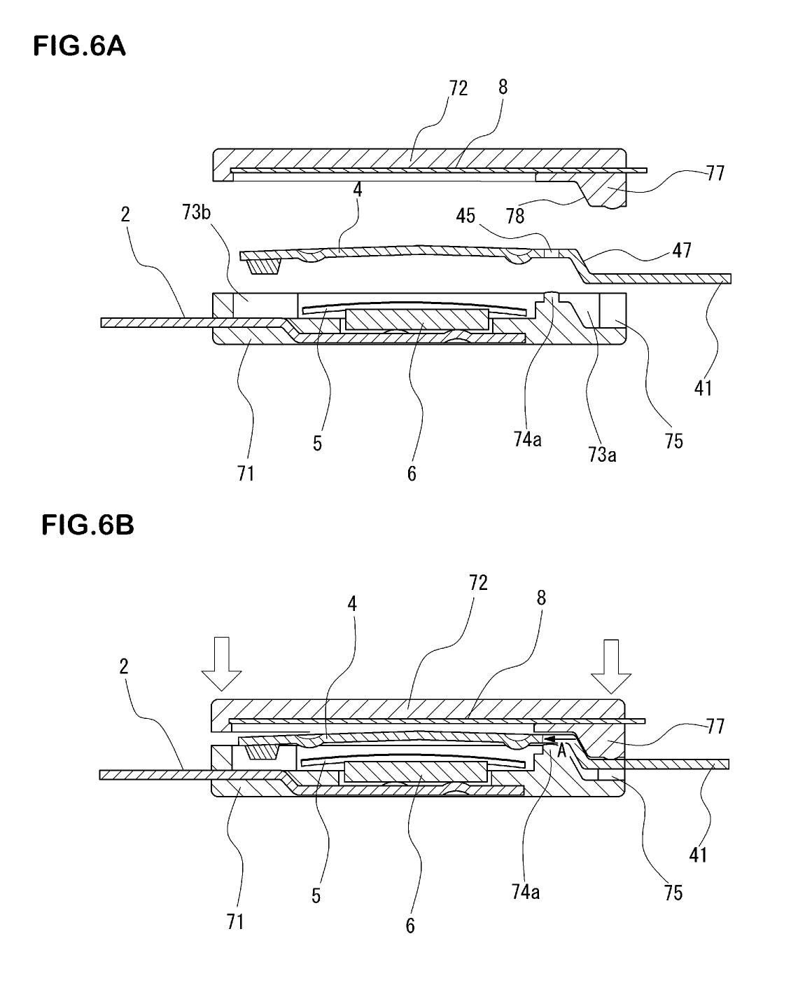

FIG. 6A and FIG. 6B show a time-series state in which the movable piece 4 is mounted on the resin base 71 and then the covering member 72 is mounted and welded.

when the movable piece 4 is mounted on the resin base 71 while being guided by the openings 73a and 73b of the resin base 71, as shown in FIG. 1,

the positioning parts 75 are engaged with the engaging parts 48 on both sides of the constricted part 49 formed in the movable piece 4, and at the same time, the protrusion 74a of the resin base 71 is inserted through the through hole 45.

By the insertion of the protrusion 74a through the through hole 45 as well as the engagement of a pair of the engaging parts 48 and a pair of the positioning parts 75, the rotational motion of the movable piece 4 relative to the resin base 71 is restricted.

Thus, the temporally positioning can be made easily.

At the stage of the temporally positioning, it is not necessary that the movable piece 4 is accurately positioned in relation to the resin base 71.

The movable piece 4 is put on the resin base 71 without being fixed thereto to enable the definite positioning in the subsequent process.

In order that the movable piece 4 is easily guided from a position to which the temporally positioning is made to the fixed position to which the definite positioning is made, the openings 73a and 73b and the protrusion 74a of the resin base 71 are formed so that their positions, shapes, dimensions and the like become analogous to those of the movable piece 4.

As shown in FIG. 6A, after the movable piece 4 has been mounted on the resin base 71, the covering member 72 is mounted on the resin base 71.

By inserting the stepped part 77 in the opening 73a of the resin base 71, and at the same time by making the positioning of the movable piece 4 by pressing the stepped part 77 onto the stepped bent part 46 of the movable piece 4, the covering member 72 is mounted on the resin base 71.

As shown in FIG. 6B, when the covering member 72 is pressed toward a direction of the resin base 71 (the direction of white outline arrows in the figure),

the slope 47 of the movable piece 4 comes into contact with the slope 78 of the covering member 72.

If the covering member 72 is further pressed toward the direction of the resin base 71, since the slope 47 and the slope 78 are formed continuously along a direction perpendicular to the longer direction of the movable piece 4,

the slope 47 of the movable piece 4 is pressed (biased) toward the longer direction of the movable piece 4 by the slope 78 of the covering member 72.

As a result, by the slopes 78 and 47, the direction of the force is changed, and the entirety of the movable piece 4 is pressed and moved toward the longer direction, namely, the direction of the arrow A where the fixed piece 2 exists.

Thus, a pair of the engaging parts 48 disposed oppositely to the slope 47 come into contact with and are engaged with a pair of the positioning parts 75 disposed oppositely to the slope 78.

Thereby, the movable piece 4, to which the temporally positioning is made by the protrusion 74a and the like, is accurately positioned in relation to the resin base 71.

Namely, an error in the temporally positioning in relation to the resin base 71 possibly occurring when the movable piece 4 is mounted, can be decreased.

Thus, it is possible to limit the positioning error of the movable piece 4 relative to the resin base 71 substantially within the range of the manufacturing error of the dimensions of the positioning part 75 of the resin base 71 and the engaging part 48 of the movable piece 4.

When the covering member 72 is mounted on the resin base 71, ultrasonic oscillation is applied to one of or both of the resin base 71 and the covering member 72, while the resin base 71 is pressed toward the covering member 72.

By the frictional heating, the contact portions of the resin base 71 and the covering member 72 (mainly, peripheral edge portions of the resin base 71 and the covering member 72) are welded, and the resin base 71 and the covering member 72 are united and construct the casing 7.

In the process shown in FIG. 6B, the fixed part 42 of the movable piece 4 is pressed toward the white outline arrow, namely, toward the resin base 71 by the contacting part 79 of the covering member 72, and

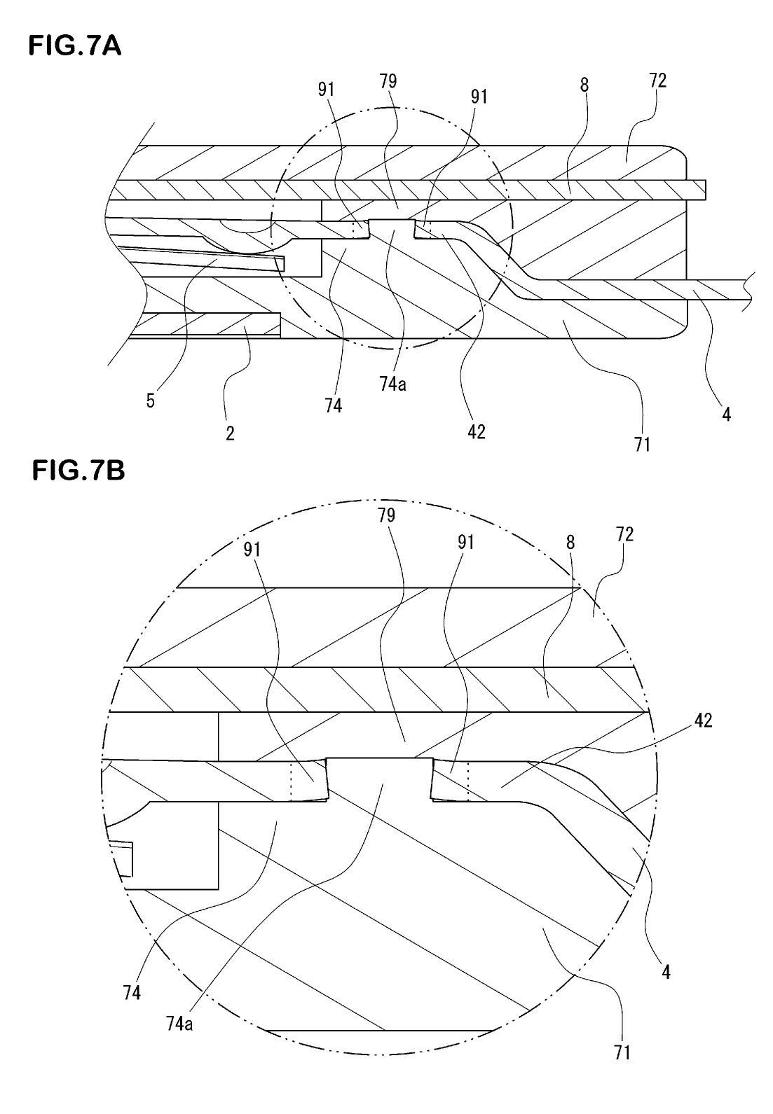

the digging-into portions 91 and 92 fit the side surface of the protrusion 74a while digging thereinto (cf. FIG. 7).

FIG. 7A shows the vicinity of the fixed part 42 in closeup. FIG. 7B shows the digging-into portions 91 fitting to the protrusion 74a and the vicinity (the region surrounded by two-dot chain line in FIG. 7A) in further closeup.

By the digging-into portions 91 and 92 digging into and fitting to the side surface of the protrusion 74a, the movable piece 4 is firmly connected to the resin base 71 in the fixed part 42.

Since this connection is brought about by the digging-into portions 91 and 92 digging into the side surface of the protrusion 74a,

even if a small gap occurs between the fixed part 42 of the movable piece 4 and the contacting part 79 of the covering member 72 due to the deformation of the covering member 72 occurring in the above-mentioned reflow soldering and the like, the connection is maintained without being affected by the gap.

Since this embodiment has such a structure that, in order to fix the fixed part 42, the paired digging-into portions 91 dig into the side surface of the protrusion 74a from its both sides in the longitudinal direction of the movable piece 4, it is possible to control the accuracy of the mounting of the movable piece 4 relative to the resin base 71 and the variation in the posture (rotational motion around an axis perpendicular to plane of paper in FIG. 7) which become problematic in the positional relation between the movable contact 3 and the fixed contact 21.

Thereby, it becomes possible to stabilize the positional relation between the movable contact 3 provided in the tip section of the movable piece 4 and the fixed contact 21 embed in the resin base 71.

As shown in FIG. 7B, the digging-into portions 91 are bent or curved so that their tip ends protrude toward the front surface side of the movable piece 4 (upward in the figure). (the same is true in the digging-into portions 92)

Such bend or curve may be provided by pressing up the digging-into portions 91 and 92 with the side surface of the protrusion 74a which contacts when the digging-into portions 91 and 92 are fitted to the side surface of the protrusion 74a, or previously provided by the press working when the through hole 45, the digging-into portions 91 and 92 and the through-holes 93 are formed in the movable piece 4.

Thus, according to the structure in which the digging-into portions 91 are bent or curved toward the front surface side of the movable piece 4,

when the movable piece 4 is, for any reason, subjected to an external force separating from the resin base 71, the digging-into portions 91 and 92 bent or curved toward the front surface side need to become flat while keeping the state digging into the side surface of the protrusion 74a, therefore, the amount of digging of the tip ends into the protrusion 74a is increased.

Thereby, the engagement between the movable piece 4 and the resin base 71 becomes further strong and the separation of the movable piece 4 can be prevented.

As explained above, according to the breaker 1 in this embodiment, as the digging-into portions 91 and 92 formed in the movable piece 4 dig into the resin base 71,

the posture of the movable piece 4 is fixed in relation to the resin base 71, namely, the movable piece 4 is firmly fixed to the resin base 71 by the digging-into portions 91 and 92, regardless of the deformation of the covering member 72.

Therefore, when the breaker 1 placed on a circuit board of the safety circuit is connected to the safety circuit by reflow soldering,

even if the covering member 72 is deformed by overheating, there is no possibility that the posture of the movable piece 4 relative to the resin base 71 is affected.

In this context, by placing the breaker 1 on the circuit board so that the covering member 72 is oriented toward blasts of hot air, the resin base 71 is protected from the blasts of hot air by the covering member 72, and the deformation of the resin base 71 can be inhibited.

Therefore, the positional relation between the movable contact 3 provided in the tip end of the movable piece 4 and the fixed contact 21 embed in the resin base 71 is still stabilized after the reflow soldering to reduce the contact resistance between the contacts under the conduction state, and

it becomes possible to maintain the good temperature property of the breaker 1.

According to the configuration in which the digging-into portions 91 and 92 are provided in the fixed part 42 sandwiched between the resin base 71 and the covering member 72, the fixation of the movable piece 4 to the casing 7 becomes further strong owing to synergistic action of the fixed part 42 and the digging-into portions 91 and 92, and it is possible to stabilize the posture of the movable piece 4.

According to the configuration in which the digging-into portions 91 and 92 are formed intermittently, the digging-into portions 91 and 92 can make elasticity deformation independently from each other, and their elastic moduli can be optimized individually.

Therefore, it becomes possible to easily perform the process for mounting the movable piece 4 in the resin base 71 by controlling the bonding force between the digging-into portions 91 and 92 and the protrusion 74a.

Further, since a plurality of the digging-into portions 91 and 92 are shifted in the direction to which the elastic portion 43 extends,

the movable piece 4 is fixed to the resin base 71 such that the digging-into portions 91 and 92 dig into the resin base 71 at plural positions in the direction to which the elastic portion 43 extends,
therefore, it becomes possible to further stabilize the posture of the movable piece 4 (especially, the position of the tip section of the elastic portion 43 where the movable contact 3 is provided: the same hereinafter).

According to the configuration in which the digging-into portions 91 and 92 are formed so as to protrude from the peripheral edge of the through hole 45 into which the protrusion 74a of the resin base 71 is inserted,

when the movable piece 4 is mounted on the resin base 71, easy and accurate positioning of the movable piece 4 is possible by inserting the protrusion 74a of the resin base 71 into the through hole 45.

Further, as the positioning structure for the movable piece 4 can double as the fixing structure, it is possible to simply the structure of the breaker 1.

According to the configuration in which the movable piece 4 is mounted in the resin base 71 from the rear surface side on which the movable contact 3 is provided, and the digging-into portions 91 and 92 are bent or curved so that the tip ends protrude toward the front surface side of the movable piece 4,

when the movable piece 4 is separating from the resin base 71, the bent or curved digging-into portions 91 and 92 are made flatter, and
the amount of digging of the tip ends is increased.

Thereby, the engagement between the movable piece 4 and the resin base 71 becomes strong, and

the separation of the movable piece 4 can be prevented.

### Modified Example 1

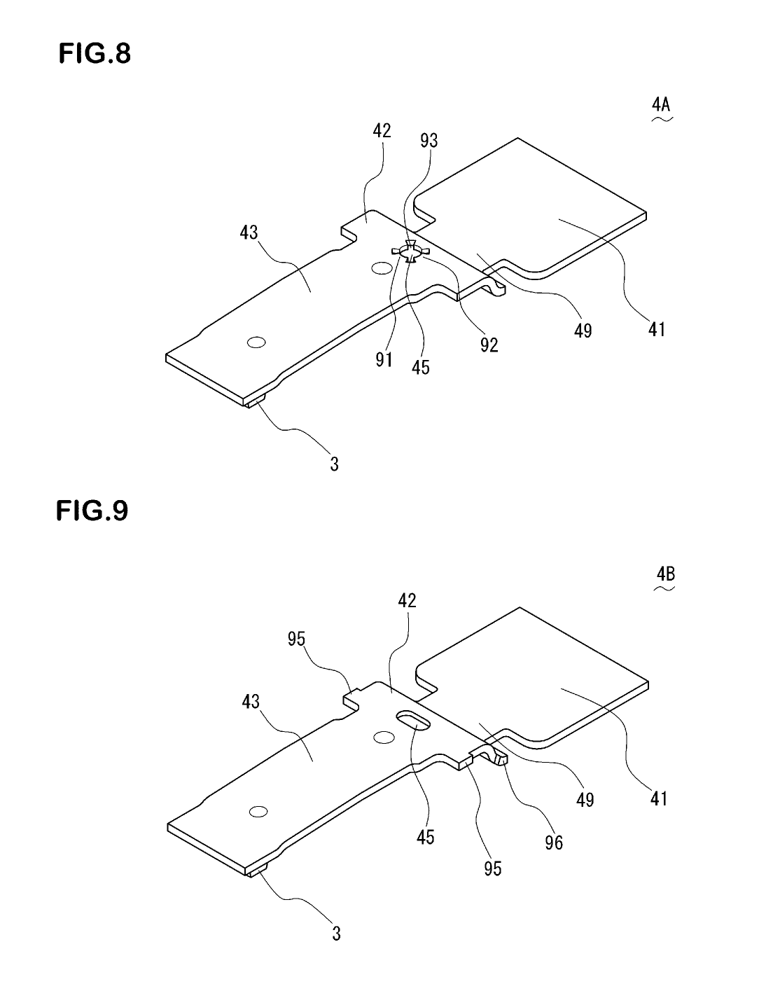

FIG. 8 shows a modified example of the movable piece. In the movable piece 4A of this modified example, the through hole 45 is formed in a circular form in the plan view which is a point of difference from the aforementioned embodiment shown in FIG. 5 etc.

Accordingly, the shape of the protrusion 74a is changed to a circular form in the plan view.

It is the same as the movable piece 4 of the aforementioned embodiment in that, by forming the through-holes 93, two pairs of the digging-into portions 91 and 92 are formed intermittently at the peripheral edge of the through hole 45.

When the protrusion 74a which is an oval or ellipse in the plan view as shown in FIG. 5, etc. is employed,

since a junction area between the top surface of the protrusion 74a and the contacting part 79 of the covering member 72 can be increased,
the joining force between the resin base 71 and the covering member 72 is increased, and it becomes possible to attempt to improve the strength of the casing 7.

When the protrusion 74a which is an oval or ellipse in the plan view is employed as in this modified example, the width dimension of the fixed part 42 (dimension in the short direction of the movable piece 4) can be made small, and it becomes possible to easily attempt to miniaturize the breaker 1.

Aside from the above-mentioned round shapes, a rectangle or any polygonal shape may be used for the shapes of the through hole 45 and the protrusion 74a in the plane view.

In the aforementioned movable pieces 4 shown in FIG. 5 or FIG. 8, the digging-into portion may be formed continuously at the peripheral edge of the through hole 45, without forming the through-holes 93 in the peripheral edge of the through hole 45.

In this case, the digging-into portion digs into and engages with the side surface of the protrusion 74a at the entire peripheral edge of the through hole 45, therefore, it is possible to make the joining between the movable piece 4 and the resin base 71 stronger.

Further, it may be good to form convexo-concave on the side surface of the protrusion 74a so that the digging-into portion intermittently digs into the protrusion 74a.

### Modified Example 2

FIG. 9 shows a modified example of the movable piece. In the movable piece 4B of this modified example, two pairs of the digging-into portions 95 and 96 are formed at the edges of the fixed part 42 which is a point of difference from the aforementioned embodiment shown in FIG. 5 etc.

In addition to the digging-into portions 95 and 96, it may be possible to form a digging-into portion intermittently or continuously at the peripheral edge of the through hole 45.

In the modified example shown in FIG. 9,

a pair of the digging-into portions 95 are formed at the edges of the fixed part 42 on the elastic portion 43 side, and
a pair of the digging-into portions 96 are formed at the edges of the fixed part 42 on the constricted part 49 side.

By making the shape of the resin base 71 to correspond to the digging-into portions 95 and 96,

the digging-into portion 95 may be formed at the edge of a root portion of the elastic portion 43, and
the digging-into portion 96 may be formed at the edge of the constricted part 49.

Each of the digging-into portions 95 and each of the digging-into portions 96 are disposed side by side in a direction parallel with the longer direction of the movable piece 4 namely, the direction to which the elastic portion 43 extends.

In other words, the digging-into portions 95 and the digging-into portions 96 are shifted in the direction to which the elastic portion 43 extends.

According to this modified example, since the digging-into portions 95 and 96 are formed at the edges of the fixed part 42, the digging-into portions 95 and 96 dig into the resin base 71 at the edges of the fixed part 42, and

the movable piece 4 is further strongly fixed to the resin base 71.

For example, as shown in FIG. 9, by forming the digging-into portions 95 and 96 at the edge of the fixed part 42 to become opposite to the side wall of the resin base 71, the movable piece 4 can be secured by the side wall which is stiff and which is a major structure of the resin base 71, and it becomes possible to further stabilize the posture of the movable piece 4.

Further, since a plurality of the digging-into portions 95 and 96 are disposed to shift in the direction to which the elastic portion 43 extends,

the digging-into portions 95 and 96 dig into the resin base 71 at a plurality of positions in the direction to which the elastic portion 43 extends, and
the movable piece 4 is fixed to the resin base 71.

Therefore, it becomes possible to further stabilize the posture of the movable piece 4.

### Modified Example 3

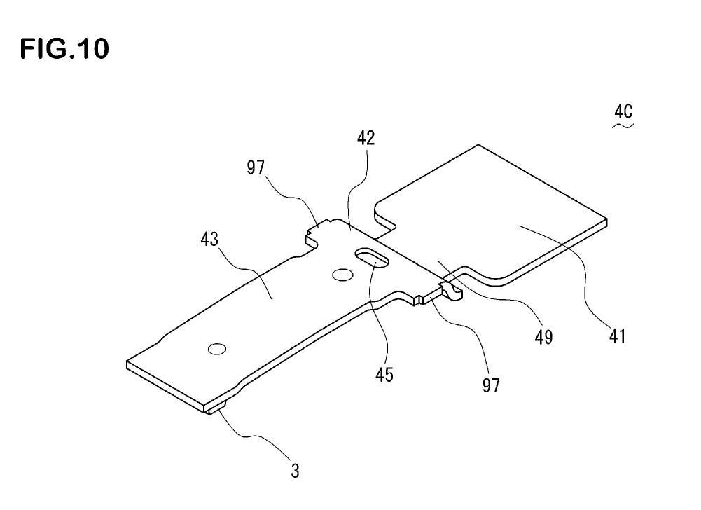

FIG. 10 shows a modified example of the movable piece. In the movable piece 4c of this modified example, a pair of the wide digging-into portions 97 are formed at the edges of the fixed part 42 which is a point of difference from the modified example shown in FIG. 9.

The width of the digging-into portion 97 (length in the direction to which the elastic portion 43 extends) is set so that a pair of the digging-into portions 97 dig into the side wall of the resin base 71 and the posture of the movable piece 4 can be stabilized.

According to this modified example, since the digging-into portions 97 are formed at the edges of the fixed part 42 similarly to the modified example shown in FIG. 9,

the digging-into portions 97 dig into the resin base 71 at the edges of the fixed part 42, and the movable piece 4 is further strongly fixed to the resin base 71.

The present invention is not restricted to the structures in the aforementioned embodiments. It is enough that the movable piece 4 has the digging-into portions 91, 92, 95, 96 or 97 digging into the resin base 71.

In the present invention, for example,

such a structure that the movable piece 4 is fixed to the resin base 71 by the paired digging-into portions 91 only, may be employed, and
such a structure that the movable piece 4 is fixed to the resin base 71 by the paired digging-into portions 92 only, may be employed.

Further, such a structure that the movable piece 4 is fixed to the resin base 71 by the paired digging-into portions 95 only, may be employed, and

such a structure that the movable piece 4 is fixed to the resin base 71 by the paired digging-into portions 96 only, may be employed.

The number of the digging-into portions is not limited, and plural pairs of the digging-into portions 91, 92, 95, 96, 97 etc may be arbitrarily combined.

Aside from the aforementioned modified examples, the present invention can be variously modified.

The configuration of the digging-into portion is not limited especially as far as it is possible to dig into a part of the resin base 71 and stabilize the posture of the movable piece 4 relative to the resin base 71.

For example, the digging-into portion is not limited to the paired structure.

Such a structure that the movable piece 4 is fixed to the resin base 71 by the single digging-into portion, is also possible.

In concrete terms, it is also possible to modify into a structure in which the movable piece 4 is fixed to the resin base 71 by using a combination of

the single digging-into portion and
another structure formed in the movable piece 4 such as the stepped bent part 46, slope 47, engaging part 48 or constricted part 49 (other structure than movable region such as the movable contact 3 or the elastic portion 43).

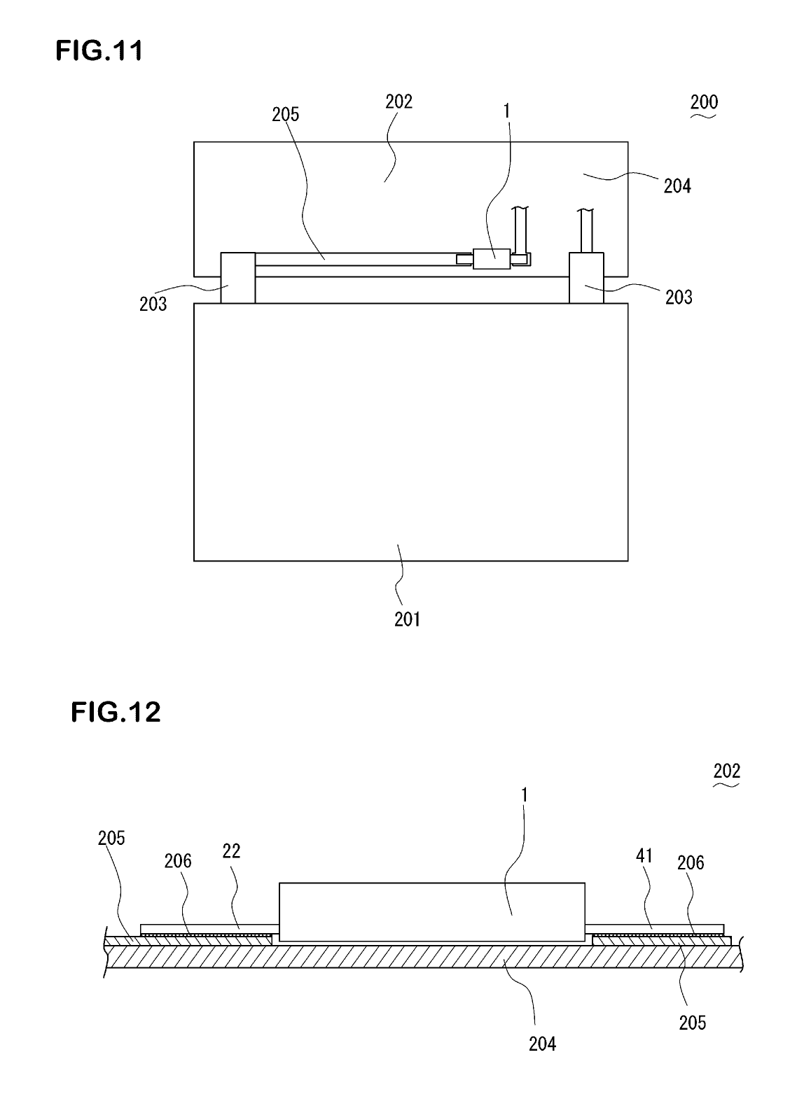

The breaker 1 according to the present invention can be applied variously to a secondary battery circuit shown in FIG. 11, safety circuit and the like.

In FIG. 1, etc., the movable piece 4 has the structures of the through hole 45, the stepped bent part 46, the slope 47, the engaging part 48 and the constricted part 49. But, any of or all of these structures can be omitted.

For example, to omit the through hole 45, the protrusion 74a of the resin base 71 and the digging-into portions 91 and 92 are omitted. Instead, the digging-into portions 95 and 96 or 97 are employed.

When the stepped bent part 46 and the slope 47 are omitted, the movable piece 4 is formed in a planar shape.

The contacting part 74 of the resin base 71 and the contacting part 79 of the covering member 72 become flat.

In this structure, owing to the omission of the stepped bent part 46 and the slope 47, it becomes possible to attempt to further miniaturize the breaker 1 by reducing the longitudinal dimensions of the movable piece 4 and the resin base 71.

The stepped bent part 46 of the movable piece 4 and the slope 47 may be provided on the outside of the resin base 71 if needed.

When the engaging part 48 and the constricted part 49 are omitted, the movable piece 4 is formed so as to have a constant width from the fixed part 42 to the terminal 41.

Accordingly, the shape of the positioning part 75 of the resin base 71 is also changed.

The joining technique for the resin base 71 and the covering member 72 is not limited to the ultrasonic welding. As far as they are strongly connected with each other, any technique can be employed.

For example, it is also possible that a liquid or gel (glue-like) adhesive agent is applied/filled and hardened and they are bonded with each other.

The casing 7 is not limited to the structure made up of the resin base 71 and the covering member 72 as far as the movable piece 4 is secured between two or more parts.

In this case, one of them is the first casing, and other/others is/are the second casing.

This embodiment has a self-holding circuit by the PTC thermistor 6. But, it is also possible to employ a mode in which such structure is omitted. In this case, it is possible to attempt to miniaturize the breaker 1 while controlling the conduction resistance.

It is also possible to employ a structure in which the movable piece 4 and the thermal actuator element 5 are integrated into one part by forming the movable piece 4 from a bimetal or trimetal. In this case, the structure of the breaker 1 is simplified, and it is possible to attempt the further miniaturization.

The present invention can be applied to the mode structurally separated into the terminal 41 side and the movable contact 3 side in the fixed part 42 or its vicinity as disclosed in Japanese patent application publication No. 2005-203277.

### DESCRIPTION OF REFERENCE SIGNS

1 breaker
2 fixed piece
3 movable contact
4 movable piece
5 thermal actuator element
7 casing
21 fixed contact
43 elastic portion
45 through hole
71 resin base (first casing)
72 covering member (second casing)
91 digging-into portion
92 digging-into portion
95 digging-into portion
96 digging-into portion
97 digging-into portion
200 secondary battery circuit
202 safety circuit

1. In a breaker comprising
a fixed piece having a fixed contact,
a movable piece having an elastically deformable elastic portion and a movable contact in a tip section of the elastic portion, for pressing the movable contact to the fixed contact so as to contact therewith,
a thermal actuator element for actuating the movable piece so that the movable contact is separated from the fixed contact by its deformation accompanying a temperature change, and
a casing for housing the fixed piece, the movable piece and the thermal actuator element,
the breaker is characterized in that
the casing has a first casing molded with the fixed piece inserted, and a second casing mounted on the first casing, and
the movable piece has a digging-into portion digging into the first casing.

2. The breaker as set forth in claim 1, characterized in that the movable piece has a fixed part sandwiched between the first casing and the second casing and fixed to the casing, and the digging-into portion is formed in the fixed part.

3. The breaker as set forth in claim 1, characterized in that a plurality of the digging-into portions are formed intermittently.

4. The breaker as set forth in claim 3, characterized in that a plurality of the digging-into portions are shifted in a direction to which the elastic portion extends.

5. The breaker as set forth in claim 1, characterized in that
the movable piece has a through hole into which a part of the first casing is inserted, and
the digging-into portion is formed to protrude from the peripheral edge of the through hole.

6. The breaker as set forth in claim 2, characterized in that the digging-into portion is formed at an edge of the fixed part.

7. The breaker as set forth in claim 1, characterized in that the movable piece is housed in the first casing from a rear surface side on which the movable contact is provided, and the digging-into portion is bent or curved so that its tip end protrudes toward a front surface side of the movable piece.

8. A safety circuit for an electrical equipments characterized by having the breaker as set forth in claim 1.

9. A secondary battery circuit characterized by having the breaker as set forth in claim 1.
